(19) United States
(12) Patent Application Publication
(10) Pub. No.: US 2021/0257883 A1
(43) Pub. Date: Aug. 19, 2021

(54) DRIVE SYSTEM FOR ELECTRIC AUTOMOBILE

(71) Applicant: LG Electronics Inc., Seoul (KR)

(72) Inventors: Jongsu KIM, Seoul (KR); Taehee KWAK, Seoul (KR); Jungwook MOON, Seoul (KR); Changhum JO, Seoul (KR)

(21) Appl. No.: 17/252,581

(22) PCT Filed: Jun. 14, 2019
(86) PCT No.: PCT/KR2019/007173

§ 371 Date: Dec. 15, 2020

(30) Foreign Application Priority Data
Jun. 15, 2018 (KR) 10-2018-0069183

(51) Int. Cl. H02K 9/19; H02K 5/20

(52) U.S. Cl. CPC H02K 9/19; B60K 2001/006; H02K 5/203

(57) ABSTRACT

The present invention relates to a drive system for an electric automobile, the drive system comprising: a motor housing having a cooling water inlet port and a cooling water outlet port formed at an upper part thereof; a first cooling water fluid channel communicating with the cooling water inlet port and the cooling water outlet port, and disposed inside the motor housing; an inverter housing including a rear cover forming the rear surface to face the motor housing in the lengthwise direction; a heat exchange plate disposed inside the rear cover and forming a second cooling water fluid channel inside thereof; a cooling water inlet hole formed at an upper part of the rear cover to communicate with a portion of the first cooling water fluid channel extending from the cooling water inlet port in the axial direction of the motor housing, and allowing cooling water introduced through the cooling water inlet port to directly flow into the second cooling water fluid channel; and a cooling water outlet hole formed at an upper part of the rear cover to be spaced apart from the cooling water inlet hole in the circumferential direction, and allowing the cooling water having cooled the heat exchange plate while moving along the second cooling water fluid channel to flow out into the first cooling water fluid channel.

### BACKGROUND

### 1. Technical Field

The present disclosure relates to a cooling structure of a drive system for an electric automobile that cools an electric motor and an inverter at the same time.

### 2. Description of the Related Art

In recent years, electric automobiles (including hybrid vehicles) provided with an electric motor as a drive source for a vehicle are in the spotlight as eco-friendly automobiles due to capability of reducing the emission of foreign substances such as fine dust.

A drive system of an electric automobile may include an electric motor that provides a power source and an inverter that drives the electric motor.

The electric motor may generate a rotational force by electromagnetic interaction between a stator and a rotor.

The inverter may convert a DC voltage of a battery into a three-phase AC voltage by switching of an IGBT (Insulated Gate Bipolar Transistor) and supplying the converted voltage to an electric motor, thereby driving the electric motor.

In a drive system for an electric automobile, cooling heat generated by the motor and the inverter performs an important role in the aspects of downsizing and efficiency improvement of the drive system.

FIG. 1 is a conceptual view for explaining the cooling action of a drive system 1 for an electric automobile in the related art.

In case of the related art, separate cooling passages for cooling an electric motor 2 and an inverter 3 are provided.

A coolant inlet port 4 and a coolant outlet port 5 are disposed in an inverter housing 3a, and coolant may flow into a cooling passage inside the inverter 3 through the coolant inlet port 4 to cool the inverter 3 and then flow out through the coolant outlet port 5.

A coolant inlet port 6 and a coolant outlet port 8 are disposed at the motor housing 2a, and a separate coolant guide pipe 7 is connected between the coolant outlet port 5 of the inverter housing 3a and the coolant inlet port 6 of a motor housing 2a.

Coolant flowing out of the inverter 3 may move to the coolant inlet port 6 of the motor housing 2a along the coolant guide pipe 7 outside the inverter housing 3a, and flow into a motor cooling passage through the coolant inlet port 6 to cool the electric motor 2 and then flow out through the coolant outlet port 8.

However, when a separate coolant guide pipe 7 for cooling the electric motor 2 and the inverter 3 is disposed as in the related art, it has an unfavorable structure in terms of weight reduction and downsizing of the vehicle.

For this reason, when the weight and size of the drive system 1 increases, there is a problem in that the mileage is reduced by an amount of charge of the same battery, and the packaging of the drive system 1 becomes difficult.

### SUMMARY

The present disclosure has been made to solve the problems in the related art, and an aspect of the present disclosure is to provide a drive system for an electric automobile in which a cooling passage for cooling an electric motor and an inverter is disposed as a single passage inside a housing, thereby increasing the efficiency and performance of the electric motor as well as greatly contributing to vehicle weight reduction and downsizing.

In order to achieve the foregoing objectives, a drive system for an electric automobile according to the present disclosure may include a motor housing accommodating a stator and a rotor thereinside, and having a coolant inlet port and a coolant outlet port at an upper portion thereof; a first coolant passage communicating with the coolant inlet port and the coolant outlet port, and provided inside the motor housing; an inverter housing having a rear cover defining a rear surface facing the motor housing in a length direction; a heat exchange plate disposed inside the rear cover to define a second coolant passage thereinside; a coolant inlet hole disposed at an upper portion of the rear cover to communicate with part of the first coolant passage extending along an axial direction of the motor housing from the coolant inlet port so as to allow coolant flowing in through the coolant inlet port to directly flow into the second coolant passage; and a coolant outlet hole disposed at an upper portion of the rear cover to be spaced apart from the coolant inlet hole in a circumferential direction so as to allow coolant that has cooled the heat exchange plate to flow out into the first coolant passage while moving along the second coolant passage.

According to an example associated with the present disclosure, the first coolant passage may include a first heat exchange cell to an Nth heat exchange cell extending along a length direction inside the motor housing; a plurality of partition walls partitioning the first to Nth heat exchange cells to be spaced apart along a circumferential direction; and a plurality of communication passages disposed at a front or rear end portion of each of the plurality of partition walls to communicate the first heat exchange cell to the Nth heat exchange cell in a circumferential direction so as to move the coolant in a zigzag pattern along a clockwise direction from the first heat exchange cell toward the Nth heat exchange cell.

According to an example associated with the present disclosure, the first heat exchange cell may be disposed to communicate with the coolant outlet hole, and the Nth heat exchange cell may be disposed to communicate with the coolant inlet hole to guide coolant flowing in through the coolant inlet port directly to the second coolant passage.

According to an example associated with the present disclosure, a barrier may be disposed inside the Nth heat exchange cell, and the barrier may partition the coolant inlet port and the coolant outlet port.

According to an example associated with the present disclosure, the motor housing may further include an extension portion extending along a radial direction, and having an oil passage thereinside, and the oil passage may include a first heat exchange cell to an Mth heat exchange cell extending along a length direction inside the extension portion; a plurality of partition walls partitioning the first to Mth heat exchange cells to be spaced apart along a circumferential direction; and a plurality of communication passages disposed at a front or rear end portion of each of the partition walls to communicate the first heat exchange cell to the Mth heat exchange cell in a circumferential direction so as to move the oil from the first heat exchange cell positioned at the lowermost end of the motor housing toward the Mth heat exchange cell positioned at the uppermost end of the motor housing in a zigzag pattern along a counterclockwise direction.

According to an example associated with the present disclosure, a plurality of oil injection ports extending in a radial direction to communicate with the Mth heat exchange cell to inject the oil into the motor housing may be provided on a partition wall positioned at the uppermost end of the plurality of partition walls provided in the first coolant passage.

According to another example associated with the present disclosure, the first coolant passage may include a plurality of passage formation portions extending along a circumferential direction inside the motor housing, and spaced apart along a length direction of the motor housing; a plurality of coolant channels disposed between the plurality of passage formation portions to allow the coolant to flow along a circumferential direction; an inlet-side common header disposed at one end of the plurality of coolant channels to distribute the coolant to the plurality of coolant channels; and an outlet-side common header disposed at the other end of the plurality of coolant channels to collect the coolant from the plurality of coolant channels.

According to another example associated with the present disclosure, the motor housing may include an outer housing disposed with the first coolant passage thereinside; an outer housing disposed outside the inner housing to surround the inner housing, and provided with the semicircular portion and the extension portion, and an extension portion extending from the outer housing in an extended manner in a radial direction to define an oil passage thereinside.

According to another example associated with the present disclosure, the oil passage may include a first heat exchange cell to an Lth heat exchange cell extending along a length direction inside the extension portion; a plurality of partition walls partitioning the first to Lth heat exchange cells to be spaced apart along a circumferential direction; and a plurality of communication passages disposed at a front or rear end portion of each of the plurality of partition walls to communicate the first heat exchange cell to the Lth heat exchange cell in a circumferential direction so as to move the oil from the first heat exchange cell positioned at the lowermost end of the extension portion toward the Lth heat exchange cell positioned at the uppermost end of the extension portion in a zigzag pattern along a counterclockwise direction.

According to another example associated with the present disclosure, the inner housing may further include a bridge extending along a length direction at the uppermost end of the inner housing; and a plurality of oil injection ports disposed at front and rear end portions of the bridge, respectively, to inject oil into the inner housing.

According to another example associated with the present disclosure, the inner housing may include a first partition wall having one end thereof connected to one end of the coolant inlet hole along a circumferential direction thereof, and the other end thereof extending in a direction crossing between the coolant inlet port and the coolant outlet port to be connected to a rear end portion of the bridge; a second partition wall having one side thereof connected to the other end of the coolant inlet hole along a circumferential direction thereof, and the other side thereof extending along a length direction of the inner housing to be connected to the first partition wall; and a coolant outlet guide portion disposed between the first partition wall and the second partition wall to allow the coolant flowing in through the coolant inlet port to flow out into the coolant inlet hole.

According to another example associated with the present disclosure, the inner housing may further include a coolant inlet guide portion disposed between the second partition wall, the bridge, and a rear portion of the first partition wall to communicate with the coolant outlet hole so as to guide the coolant flowing into the inner housing through the coolant outlet hole to the inlet-side common header, and the bridge may be provided with a coolant communication hole to communicate the coolant inlet guide portion and the inlet-side common header at a lower portion thereof.

The effects of a drive system for an electric automobile according to the present disclosure will be described as follows.

First, an inverter housing and a motor housing may be coupled in an axial direction, and a coolant inlet hole and a coolant outlet hole for communicating a coolant passage of the inverter housing and a coolant passage of the motor housing may be disposed on a rear surface of the inverter housing, thereby allowing the coolant passage of an inverter and the coolant passage of an electric motor to be disposed as a single passage in a housing.

Second, a coolant guide pipe that connects the coolant passage of the inverter and the coolant passage of the electric motor may not be required, thereby achieving weight reduction and downsizing of the vehicle.

Third, the mileage compared to an amount of charge of the same battery may be extended, and the packaging of the drive system may be facilitated through weight reduction and downsizing of the vehicle.

### BRIEF DESCRIPTION OF THE DRAWINGS

FIG. 1 is a conceptual view for explaining the cooling action of a drive system 1 for an electric automobile in the related art.

FIG. 2 is a perspective view showing an appearance of a drive system for an electric automobile according to a first embodiment of the present disclosure.

FIG. 3 is a conceptual view showing a movement path of coolant flowing between an inverter housing and a motor housing in FIG. 2.

FIG. 4 is a side view showing an inverter heat exchange plate, an inverter housing, and a motor housing exploded in an axial direction in FIG. 3.

FIG. 5 is a front view taken along a V-direction in FIG. 3.

FIG. 6 is a cross-sectional view taken along line VI-VI in FIG. 5, and FIG. 7 is a cross-sectional view taken along line VII-VII in FIG. 5.

FIG. 8 is a front view showing a motor housing viewed in an axial direction along line VIII-VIII in FIG. 4.

FIG. 9 is a front view showing an inverter housing viewed in an axial direction along line IX-IX in FIG. 4.

FIG. 10 is a front view showing an inverter heat exchange plate viewed in an axial direction along line X-X in FIG. 4.

FIG. 11 is a rear view showing a rear surface of the inverter heat exchange plate in FIG. 10.

FIG. 12 is a conceptual view for explaining a cooling structure of an inverter housing and a motor housing according to a second embodiment of the present disclosure.

FIG. 13 is a front view showing an outer housing viewed in a direction of XIII-XIII in FIG. 12.

FIG. 14 is a cross-sectional view taken along line XIV-XIV in FIG. 12.

FIG. 15 is a conceptual view showing a state in which a multi-cooling water channel is disposed in an inner housing subsequent to removing the outer housing of the motor housing in FIG. 12.

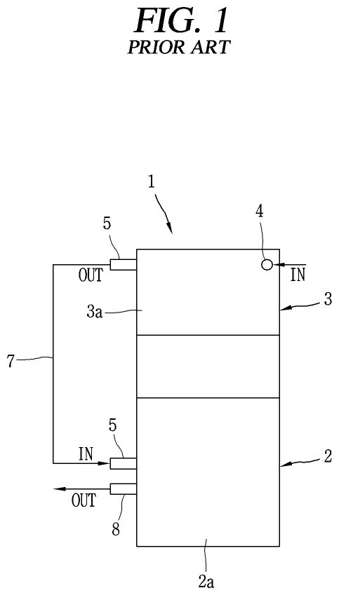

### DETAILED DESCRIPTION OF THE EMBODIMENTS

Hereinafter, the embodiments disclosed herein will be described in detail with reference to the accompanying drawings, and the same or similar elements are designated with the same numeral references regardless of the numerals in the drawings and redundant description thereof will be omitted. A suffix “module” and “unit” used for constituent elements disclosed in the following description is merely intended for easy description of the specification, and the suffix itself does not give any special meaning or function. In describing the embodiments disclosed herein, moreover, the detailed description will be omitted when specific description for publicly known technologies to which the invention pertains is judged to obscure the gist of the present invention. Also, it should be understood that the accompanying drawings are merely illustrated to easily explain the concept of the invention, and therefore, they should not be construed to limit the technological concept disclosed herein by the accompanying drawings, and the concept of the present disclosure should be construed as being extended to all modifications, equivalents, and substitutes included in the concept and technological scope of the invention.

It will be understood that, although the terms first, second, etc. may be used herein to describe various elements, these elements should not be limited by these terms. The terms are used merely for the purpose to distinguish an element from another element.

It will be understood that when an element is referred to as being “connected with” another element, the element can be directly connected with the other element or intervening elements may also be present. On the contrary, in case where an element is “directly connected” or “directly linked” to another element, it should be understood that any other element is not existed therebetween.

A singular expression includes a plural expression unless the context clearly indicates otherwise.

Terms “include” or “has” used herein should be understood that they are intended to indicate the existence of a feature, a number, a step, a constituent element, a component or a combination thereof disclosed in the specification, and it may also be understood that the existence or additional possibility of one or more other features, numbers, steps, constituent elements, components or combinations thereof are not excluded in advance.

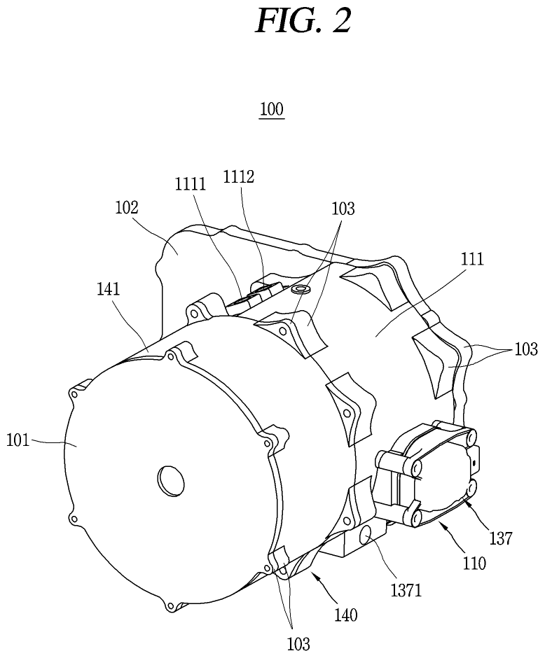

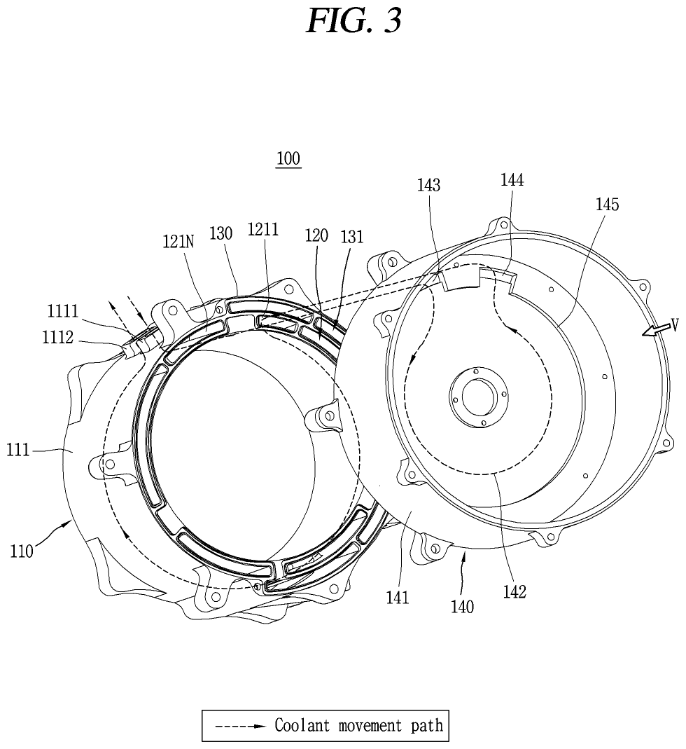

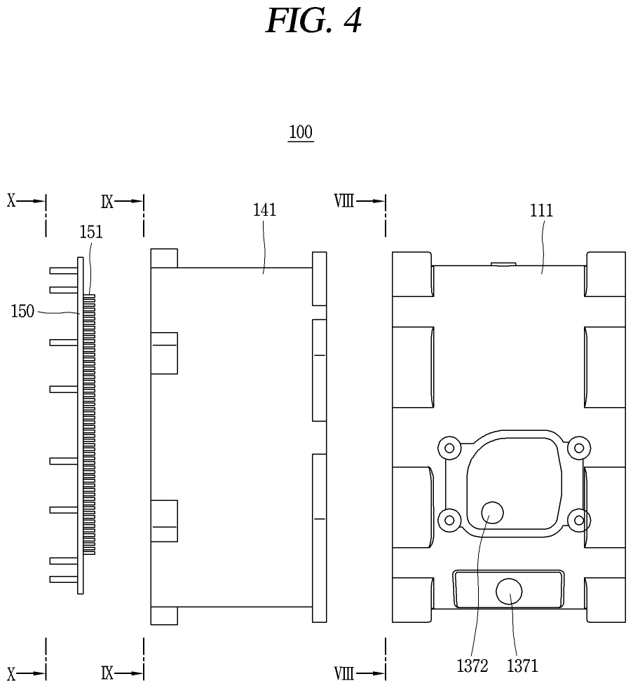

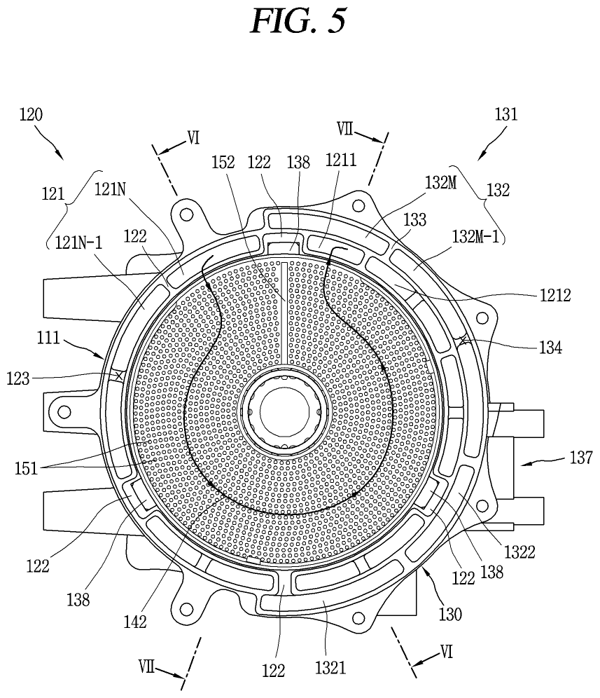

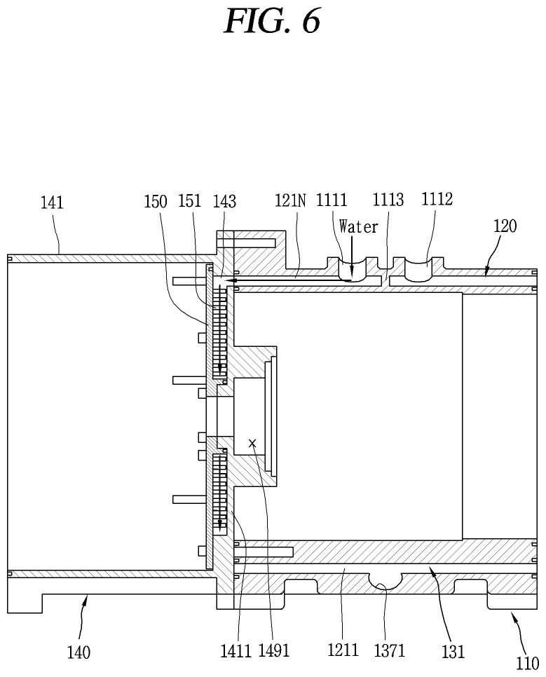

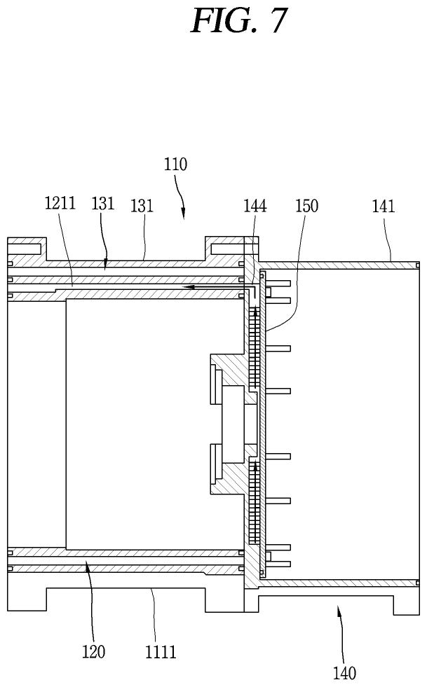

FIG. 2 is a perspective view showing an appearance of a drive system 100 for an electric automobile according to a first embodiment of the present disclosure, and FIG. 3 is a conceptual view showing a movement path of coolant flowing between an inverter housing 141 and a motor housing 111 in FIG. 2, and FIG. 4 is a side view showing an inverter heat exchange plate 150, the inverter housing 141, and the motor housing 111 exploded in an axial direction in FIG. 3, and FIG. 5 is a front view taken along a V-direction in FIG. 3, and FIG. 6 is a cross-sectional view taken along line VI-VI in FIG. 5, and FIG. 7 is a cross-sectional view taken along line VII-VII in FIG. 5.

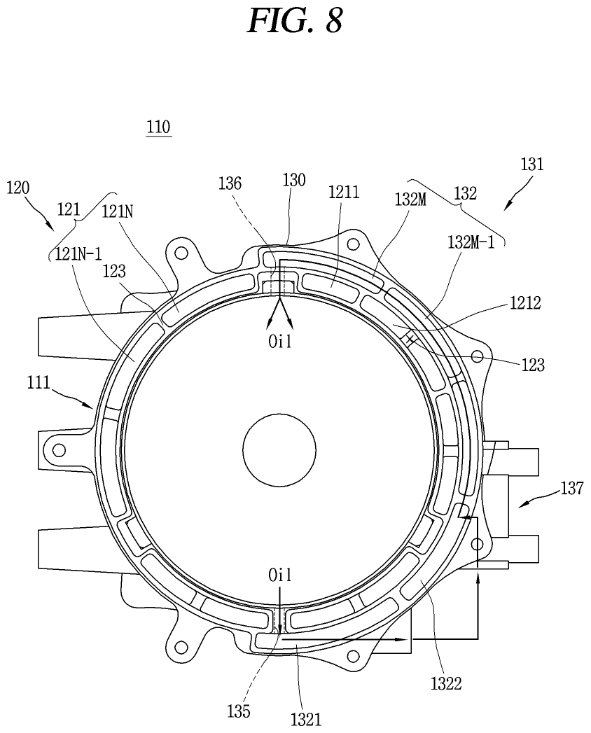

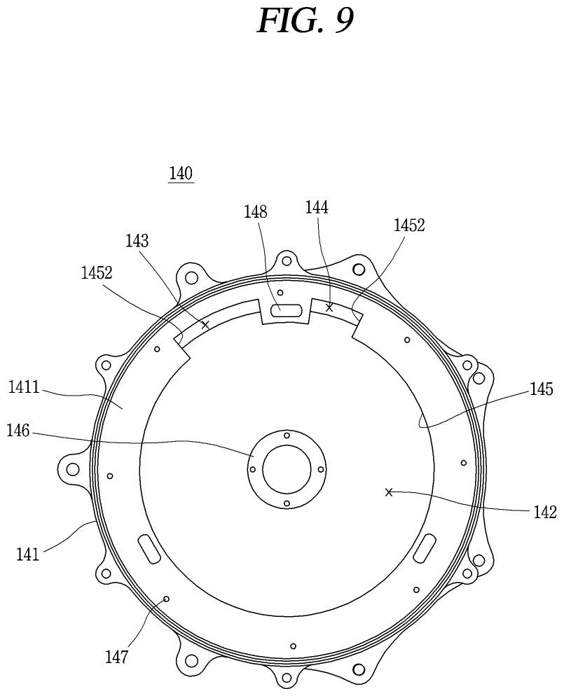

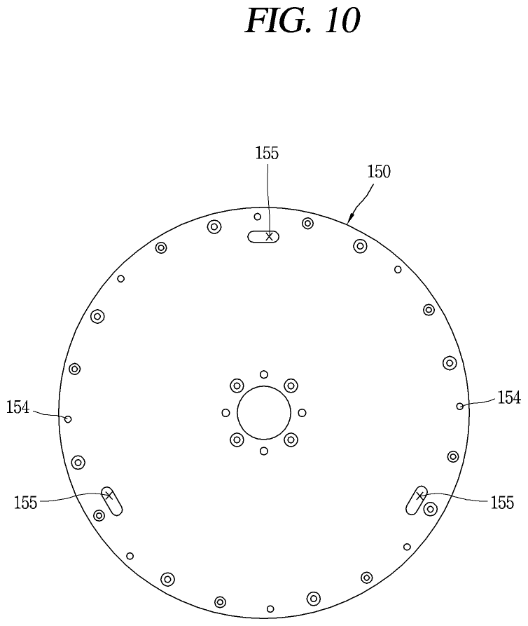

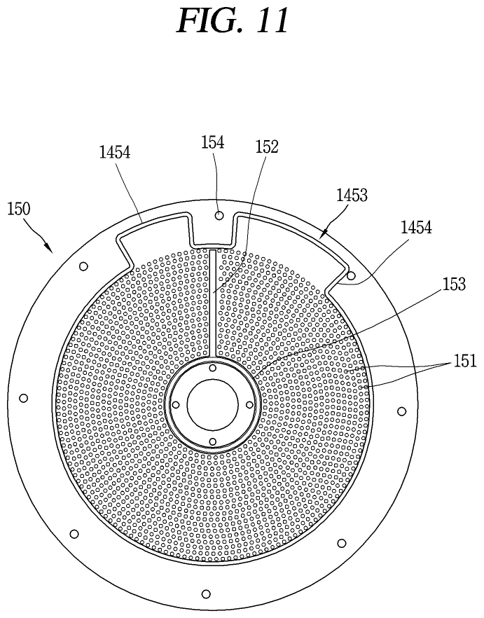

FIG. 8 is a front view showing the motor housing 111 viewed in an axial direction along line VIII-VIII in FIG. 4, and FIG. 9 is a front view showing the inverter housing 141 viewed in an axial direction along line IX-IX in FIG. 4, and FIG. 10 is a front view showing the inverter heat exchange plate 150 viewed in an axial direction along line X-X in FIG. 4, and FIG. 11 is a rear view showing a rear surface of the inverter heat exchange plate 150 in FIG. 10.

The drive system 100 may include an electric motor 110 and an inverter 140.

The electric motor 110 may include a stator and a rotor, and the stator may include a stator core and a stator coil, and the rotor may be rotatably provided around a rotation shaft at an inner side of the stator core.

The rotor may have a rotor core and a permanent magnet. The rotation shaft may be disposed at the inner center of the rotor core.

When 3-phase power is applied to the stator coil, a magnetic field is generated, and the rotor is rotated by the magnetic field, and power is generated.

The inverter 140 may convert DC voltage applied from a battery into AC voltage using a switching element such as an IGBT to supply the converted AC voltage to the electric motor 110.

The appearance of the drive system 100 may include a front cover 101, an inverter housing 141, a motor housing 111, and a rear cover 102.

The inverter housing 141 may be configured in a cylindrical shape to accommodate electronic components such as a switching element thereinside.

The motor housing 111 may be configured in a cylindrical shape to accommodate the stator and the rotor thereinside.

The inverter housing 141 and the motor housing 111 may be disposed at the front and rear sides along an axial direction and coupled to each other.

The front cover 101 may be configured to cover a front side of the inverter housing 141 along an axial direction of the rotation shaft, and the rear cover 102 may be configured to cover a rear side of the motor housing 111.

Each of the front cover 101, the inverter housing 141, the motor housing 111, and the rear cover 102 may include a plurality of fastening portions 103 so as to be coupled to each other in an axial direction. Each of the plurality of fastening portions 103 may be disposed to protrude in a radially outward direction, and spaced apart from each other along a circumferential direction.

The fastening portions 103 of the inverter housing 141 may be disposed at front and rear end portions thereof, respectively, along a length direction of the inverter housing 141, and the front end portion of the inverter housing 141 may be fastened to the front cover 101 in an axial direction with bolts, and the rear end portion of the inverter housing 141 may be fastened to a front end portion of the motor housing 111 in an axial direction with bolts.

The fastening portions 103 of the motor housing 111 may be disposed at front and rear end portions thereof along a length direction of the motor housing 111, and the front end portion of the motor housing 111 may be fastened to a rear end portion of the inverter housing 141 in an axial direction with bolts, and the rear end portion of the motor housing 111 may be fastened to the rear cover 102 in an axial direction with bolts.

Each of the motor housing 111 and the inverter housing 141 may include first and second coolant passages 142.

A first coolant passage 120 may be disposed inside the motor housing 111.

A coolant inlet port 1111 and a coolant outlet port 1112 may be disposed to protrude at an upper portion of the motor housing 111, and the coolant inlet port 1111 and the coolant outlet port 1112 may be connected to a coolant circulation system separately provided outside.

A barrier 1113 (see FIG. 6) for partitioning the coolant inlet port 1111 and the coolant outlet port 1112 may be disposed inside the motor housing 111.

The coolant circulation system may include a radiator and a plurality of coolant pipes provided in the vehicle. One of the plurality of coolant pipes may connect the radiator and the coolant inlet port 1111, and the other one thereof may connect the radiator and the coolant outlet port 1112.

The coolant inlet port 1111 may be connected to communicate with the first coolant passage 120.

The first coolant passage 120 may be connected to communicate with the second coolant passage 142.

The first coolant passage 120 extends along a longitudinal or axial direction of the motor housing to move coolant from the motor housing 111 to the inverter housing 141.

The second coolant passage 142 may be disposed in the rear cover 1411 defining a rear surface of the inverter housing 141.

The second coolant passage 142 may extend along a circumferential direction in a ring shape from the rear cover 1411. The coolant may move in a counterclockwise direction from the rear cover 1411 of the inverter housing 141.

A coolant inlet hole 143 and a coolant outlet hole 144 may be in the rear cover 1411 of the inverter housing 141 to allow the inverter housing 141 and the motor housing 111 to communicate with each other in an axial direction.

The coolant inlet hole 143 is a communication hole for allowing coolant to flow from the motor housing 111 to the inverter housing 141, and the coolant outlet hole 144 is a communication hole for allowing coolant to flow from the inverter housing 141 to the motor housing 111.

Each of the coolant inlet hole 143 and the coolant outlet hole 144 may extend along a circumferential direction in the form of an arc-shaped slot having a narrow width and a long length at an upper portion of the rear cover 1411. The coolant inlet hole 143 and the coolant outlet hole 144 may be spaced apart from each other at the left and right sides, respectively, in a circumferential direction.

The heat exchange plate 150 may be provided inside the inverter housing 141 to cool electric and electronic components accommodated in the inverter housing 141. The heat exchange plate 150 may be spaced apart from the rear cover 1411 at a predetermined interval to define the second coolant passage 142.

A center hole is disposed at a central portion of the heat exchange plate 150 to allow the rotation shaft to pass therethrough. The heat exchange plate 150 may include a central partition wall 152 extending in a radial direction from an upper end portion of the center hole in a direction crossing between the coolant inlet hole 143 and the coolant outlet hole 144.

The central partition wall 152 may divide the coolant passage in which coolant flowing in through the coolant inlet hole 143 is disposed between a rear surface of the heat exchange plate 150 and an inner surface of the rear cover 1411 into both sides thereof. One side of the second coolant passage 142 may communicate with the coolant inlet hole 143 and the other side of the second coolant passage 142 may communicate with the coolant outlet hole 144 with respect to the central partition wall 152.

The coolant flowing into the inverter housing 141 through the coolant inlet hole 143 may rotate in a counterclockwise direction along the second coolant passage 142 by the central partition wall 152.

A coolant receiving portion 145 for accommodating coolant may be disposed on an inner side of the rear cover 1411. The coolant receiving portion 145 may be disposed to be concave in a thickness direction of the rear cover 1411. The coolant receiving portion 145 may be defined in a cylindrical shape.

A plurality of communication portions 1452 for independently communicating each of the coolant inlet hole 143 and the coolant outlet hole 144 to the coolant receiving portion 145 on an inner surface of the rear cover 1411 may extend above the coolant receiving portion 145.

A partition wall 1451 for partitioning the coolant inlet hole 143 and the coolant outlet hole 144 from each other may extend in a radial direction between the coolant inlet hole 143 and the coolant outlet hole 144. An inner end portion of the partition wall 1451 may be disposed to be adjacent to or in contact with an upper end portion of the central partition wall 152 in a radial direction.

A sealing member 1453 may be provided along an inner edge portion of the coolant receiving portion 145. The sealing member 1453 may be defined in a ring shape, and may further disposed with an extension portion 1454 extending along an edge portion of the plurality of communication portions 1452 from an upper side of the sealing member 1453. The sealing member 1453 may prevent coolant from flowing out from the second coolant passage 142 to the outside.

A plurality of heat exchange fins 151 may be disposed to protrude in an axial direction in the form of a cylindrical rod on one surface of the heat exchange plate 150 disposed to face the rear cover 1411 in a length direction to expand a heat exchange area between the heat exchange plate 150 and the coolant.

The plurality of heat exchange fins 151 may be arranged in a zigzag shape along a radial direction to increase heat exchange efficiency.

At the rear center of the heat exchange plate 150, a coupling rib 153 may be disposed to protrude in a cylindrical shape along a circumferential direction of the center hole, and fastened to the rear cover 1411 in an axial direction with bolts.

The rear cover 1411 may extend in a radial direction at a rear end portion of the inverter housing 141 to partition an inner space of the inverter housing 141 and an inner space of the motor housing 111.

A bearing receiving portion 149 may be disposed at the center of the rear cover 1411 to protrude along an axial direction toward the motor housing 111. The bearing receiving portion 149 may be disposed in a cylindrical shape to accommodate a bearing therein.

The bearing receiving portion 149 may be accommodated inside the motor housing 111 when the inverter housing 141 and the motor housing 111 are assembled. A rotation shaft receiving portion 1491 is disposed inside the bearing receiving portion 149 to allow the rotation shaft to pass therethrough.

At the center of the rear cover 1411, a coupling rib 146 may be disposed to protrude along an axial direction in a direction opposite to the bearing receiving portion 149. The coupling rib 153 of the heat exchange plate 150 may be coupled to overlap the coupling rib 146 of the rear cover 1411 in a radial direction. Either one of the two coupling ribs 146, 153 may be inserted into the other one thereof. In the present embodiment, it is shown a state in which the coupling rib 146 of the rear cover 1411 is inserted into the coupling rib 153 of the heat exchange plate 150.

A plurality of coupling protrusions 147 may be disposed at an inner edge portion of the rear cover 1411. The plurality of coupling protrusions 147 may be spaced apart in a circumferential direction.

A plurality of coupling holes may be disposed at an edge portion of the heat exchange plate 150. Each of the plurality of coupling holes may be disposed to correspond to the coupling protrusions 147 in a thickness direction of the heat exchange plate 150 to allow the coupling protrusions 147 to be inserted into the coupling holes, thereby preventing the heat exchange plate 150 from being rotated or shaken up, down, left, and right inside the inverter housing 141.

The first coolant passage 120 may include a plurality of heat exchange cells 121.

Each of the plurality of heat exchange cells 121 may extend along a length direction of the motor housing 111. The plurality of heat exchange cells 121 may be partitioned from each other along a circumferential direction by a plurality of partition walls 122 and may be spaced apart from each other in a circumferential direction.

Each of the plurality of heat exchange cells 121 may be disposed to be open in a front-rear direction. Each of the plurality of heat exchange cells 121 may be disposed to allow the front end portion to be covered by the rear cover 1411 of the inverter housing 141 and the rear end portion to be covered by the rear cover 102.

Each of the plurality of partition walls 122 may extend along a length direction of the motor housing 111, and may be spaced apart along a circumferential direction.

The plurality of partition walls 122 may be disposed to be shorter in length than the motor housing 111. A front or rear end of each partition walls 122 in a length direction thereof may be disposed to overlap a front or rear end of the motor housing 111 in a length direction thereof.

For example, when a front end portion of one of the partition walls 122 is disposed to overlap a front end portion of the motor housing 111 in a radial direction, a rear end portion of the partition wall 122 may be spaced apart forward from a rear end portion of the motor housing 111 along a length direction.

Furthermore, when a rear end portion of the other partition wall 122 is disposed to overlap a rear end portion of the motor housing 111 in a radial direction, a front end portion of the partition wall 122 may be spaced apart rearward from a front end portion of the motor housing 111 along a length direction.

A communication passage 123 may be disposed in each of the plurality of partition walls 122 to allow the plurality of heat exchange cells 121 to communicate with each other. The plurality of communication passages 123 may be disposed in a zigzag pattern along a circumferential direction.

The communication passage 123 may be disposed between a rear end portion of the partition wall 122 and a rear end portion of the motor housing 111 along a length direction of the motor housing 111, or disposed between a front end portion of the partition wall 122 and a front end portion of the motor housing 111.

The plurality of heat exchange cells 121 may include a first heat exchange cell 1211 communicating with the coolant outlet hole 144; an Nth heat exchange cell 121N communicating with the coolant outlet port 1112; and second to (N-1)th heat exchange cells 1212 to 121N-1 disposed in a clockwise order between the first heat exchange cell 1211 and the Nth heat exchange cell 121N.

The Nth heat exchange cell 121N may communicate with the coolant inlet port 1111 disposed at an upper portion of the motor housing 111, and may communicate with the coolant inlet hole 143 of the inverter housing 141 disposed at a front end of the motor housing 111.

The plurality of heat exchange cells 121 may be configured with a total of 12 heat exchange cells 121 including five heat exchange cells 121 disposed on the left side and seven heat exchange cells 121 disposed on the right side with respect to the center line in a vertical diameter direction.

The five heat exchange cells 121 disposed on the left side may have a larger width of the heat exchange cells 121 extending along a circumferential direction compared to the seven heat exchange cells 121 disposed on the right side.

This is to extend a heat exchange time of coolant flowing along the right semicircle more than that of coolant flowing along the left semicircle because the number of heat exchange cells 121 increases for the seven heat exchange cells 121 disposed on the right side compared to the five heat exchange cells 121 disposed on the left side.

The coolant flowing along the left five heat exchange cells 121 may be configured to absorb heat from the stator core in contact with an inner surface of the motor housing 111, and the coolant flowing along the right seven heat exchange cells 121 may be configured to absorb heat from oil through heat exchange with the oil, which will be described later, as well as the stator core in contact with an inner surface of the stator core.

The motor housing 111 may further include a semi-cylindrically-shaped extension portion 130 extending in a radially outward direction on a circumferential surface of the right semicircle.

The extension portion 130 may include a plurality of heat exchange cells 132 through which oil flows therein.

Each of the plurality of heat exchange cells 132 may extend along a length direction of the motor housing 111. The plurality of heat exchange cells 132 may be spaced apart along a circumferential direction of the motor housing 111 by a plurality of partition walls 133 extending along a length direction of the motor housing 111.

The plurality of heat exchange cells 132 may be connected to communicate with each other by a communication passage 134 disposed at a front or rear end portion of the plurality of partition walls 133. The plurality of communication passages 134 may be disposed at the plurality of partition walls 133 in a zigzag pattern along a circumferential direction.

An oil inlet port 135 may be disposed at an inner bottom surface of the motor housing 111. The oil inlet port 135 may be disposed at the partition wall 133 positioned at the lowest end of the plurality of partition walls 133 to pass therethrough along a radial direction.

Oil injection ports 136 may be disposed at an inner uppermost end of the motor housing 111. The oil injection ports 136 may be disposed at front and rear end portions of the motor housing 111, respectively, to inject oil to end coils positioned at the front and rear end portions along a length direction of the stator coil.

The oil injection port 136 may be disposed at front and rear end portions of the partition wall 133, respectively, positioned at the uppermost end of the plurality of partition walls 133.

The plurality of heat exchange cells 132 through which oil flows may include a first heat exchange cell 1321 positioned at the lowermost end of the extension portion 130 to communicate with the oil inlet port 135; an Mth heat exchange cell 132M positioned at the uppermost end of the extension portion 130 to communicate with the oil injection port 136; and second to (M-1)th heat exchange cells 1322 to 132M-1 spaced apart from each other along a circumferential direction between the first heat exchange cell 1321 and the Mth heat exchange cell 132M.

An oil pump 137 may be mounted on the right side of the motor housing 111, and the oil pump 137 may be configured to suck oil flowing into the first heat exchange cell 1321 and then provide circulation power to the oil.

The oil pump 137 may be configured to discharge high-pressure oil to the second heat exchange cell 1322.

An oil suction hole 1371 for communicating the first heat exchange cell 1321 and the oil pump 137 to suck oil may be disposed inside a lower right end portion of the motor housing 111. The oil suction hole 1371 may be connected to an elbow-shaped oil connection pipe to allow oil to flow into the oil pump 137.

An oil discharge hole 1372 for communicating the second heat exchange cell 1322 and the oil pump 137 to discharge oil may be disposed inside a lower right side of the motor housing 111. The oil discharge hole 1372 may be positioned higher than the oil suction hole 1371.

The first heat exchange cell 1321 and the second heat exchange cell 1322 are partitioned by the partition wall 133, and unlike the other partition walls 133, the partition wall 133 between the first heat exchange cell 1321 and the second heat exchange cell 1322 is not disposed with the communication passage 134.

This is to minimize the pressure loss of the oil pump 137 that pumps oil from the second heat exchange cell 1322 to the Mth heat exchange cell 132M by allowing the first heat exchange cell 1321 to accommodate oil flowing in through the oil inlet port 135 but preventing the oil discharged from the oil pump 137 from flowing in again from the second heat exchange cell 1322 to the first heat exchange cell 1321.

A plurality of fastening protrusions 138 may be disposed to protrude in a length direction at a front end portion of the motor housing 111. The plurality of fastening protrusions 138 may be spaced apart in a circumferential direction.

The plurality of fastening protrusions 138 may include three fastening protrusions 138 disposed at equal intervals (120 degrees apart) along a circumferential direction.

The fastening protrusion 138 positioned at the uppermost end of the plurality of fastening protrusions 138 may extend along a length direction from the partition wall 122 positioned at the uppermost end of the motor housing 111, and the fastening protrusion 138 positioned on the right side may extend along a length direction from the partition wall 122 between the fifth and sixth heat exchange cells 121, and the fastening protrusion 138 positioned on the left side may extend along a length direction from the partition wall 122 between the ninth and tenth heat exchange cells 121.

Each fastening protrusion 138 may be configured to fasten the motor housing 111 and the inverter housing 141.

A plurality of fastening holes 148 may be disposed at an edge portion of the rear cover 1411 of the inverter housing 141. Each of the plurality of fastening holes 148 may be disposed at positions corresponding to the plurality of fastening protrusions 138 in a thickness direction.

The plurality of fastening holes 148 may be disposed at an edge portion of the heat exchange plate inserted and mounted in the inverter housing 141 along a length direction. Each of the plurality of fastening holes 148 may be disposed at positions corresponding to the plurality of fastening protrusions 138 in a thickness direction.

The fastening protrusions 138 of the motor housing 111 may be inserted through the fastening holes 148 of each of the inverter housing 141 and the heat exchange plate to allow the inverter housing 141 and the motor housing 111 to be easily assembled in an axial direction.

The inverter housing 141 and the motor housing 111 may be coupled to each other prior to screw-fastening the fastening portion 103 of the inverter housing 141 and the fastening portion 103 of the motor housing 111 with bolts, thereby restricting movement in up, down, left, and right or rotation in a circumferential direction.

According to this configuration, while the inverter housing 141 and the motor housing 111 are temporarily fastened by the fastening protrusions 138, the fastening portion 103 of the motor housing 111 and the fastening portion 103 of the inverter housing 141 may be screw-fastened with bolts to complete assembly between the two components, thereby improving assembly performance.

In addition, the inverter housing 141 and the motor housing 111 may allow slide coupling with each other along an axial direction by the fastening holes 148 and the fastening protrusions 138, but restrict rotation in a circumferential direction, thereby facilitating the coolant outlet hole 144 of the inverter housing 141 and the first heat exchange cell 1211 of the coolant passage to be aligned to communicate with each other in an axial direction.

The cooling action of the inverter 140 and the electric motor 110 to which the oil-water cooling complex cooling method of the present disclosure is applied according to this configuration will be described.

A drive system according to the present disclosure may allow coolant to flow along a single coolant passage inside the inverter housing 141 and the motor housing 111, thereby cooling the inverter 140 and the electric motor 110.

The coolant cooled in a coolant circulation system may flow in through the coolant inlet port 1111 of the motor housing 111.

The coolant flowing into the motor housing 111 may flow into the inverter housing 141 to cool the inverter 140 primarily, and then flow back into the motor housing 111 from the inverter housing 141 to cool the electric motor 110 secondarily.

The reason of cooling the inverter 140 first and then cooling the electric motor 110 is because the temperature of heat generated from the inverter 140 is higher than that of heat generated from the electric motor 110, and cooling the inverter 140 first and then cooling the electric motor 110 is more effective in terms of cooling efficiency.

If the electric motor 110 is cooled first and then the inverter 140 is cooled, the temperature of coolant flowing from the motor housing 111 to the inverter housing 141 is higher than the vice versa, and an amount of heat dissipated from the heat exchanger plate of the inverter housing 141 is inevitably reduced by that amount.

Therefore, in order to increase the heat dissipation performance of coolant, it is preferable to cool the inverter 140 first and then cool the electric motor 110.

According to the present disclosure, the heat exchange cell 132 of the extension portion 130 may define an oil passage 131, and oil may be cooled through heat exchange with coolant flowing along a coolant passage while moving in a counterclockwise direction from the lowermost to the uppermost end of the motor housing 111 along the oil passage 131, thereby allowing the oil to absorb more heat from the stator coil when the oil is injected directly to the stator coil.

In addition, the inverter housing 141 and the motor housing 111 may be coupled in an axial direction, but the coolant inlet hole 143 and the coolant outlet hole 114 for communicating the second coolant passage 142 and the first coolant passage 120 may be disposed on a rear surface of the inverter housing 141, thereby allowing the coolant passage of the inverter 140 and the coolant passage of the electric motor 110 to be defined as a single passage in the housing.

Moreover, a coolant guide pipe connecting the coolant passage of the inverter 140 and the coolant passage of the electric motor 110 may not be required, thereby achieving weight reduction and downsizing of the vehicle.

Besides, there is an advantage in that the mileage compared to an amount of charge of the same battery is extended, and the packaging of the drive system is facilitated through weight reduction and downsizing of the vehicle.

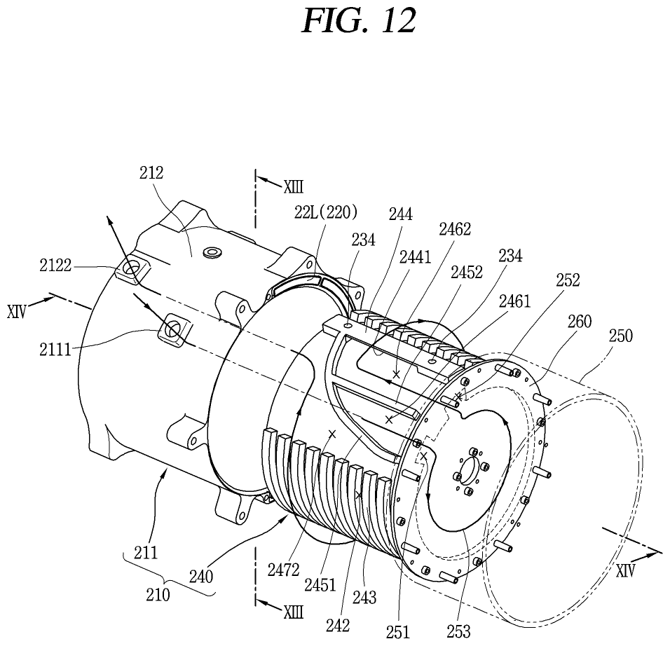

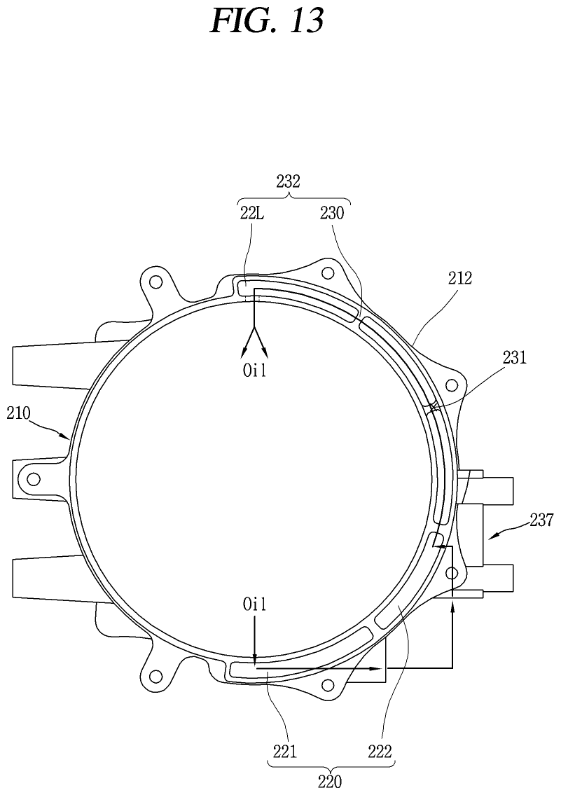

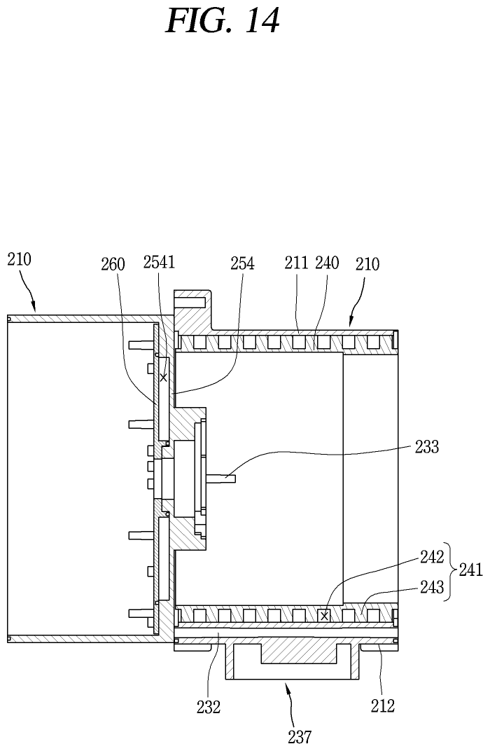

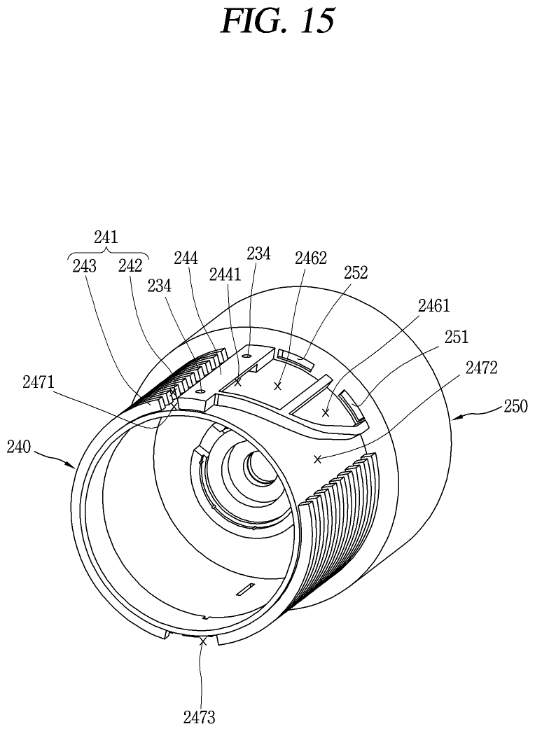

FIG. 12 is a conceptual view for explaining a cooling structure of an inverter housing 250 and a motor housing 210 according to a second embodiment of the present disclosure, and FIG. 13 is a front view showing an outer housing 211 viewed in a direction of XIII-XIII in FIG. 12, and FIG. 14 is a cross-sectional view taken along line XIV-XIV in FIG. 12, and FIG. 15 is a conceptual view showing a state in which a multi-cooling water channel 242 is disposed in an inner housing 240 subsequent to removing the outer housing 211 of the motor housing 210 in FIG. 12.

The motor housing 210 according to a second embodiment is different from the first embodiment in that the motor housing 210 is composed of the outer housing 211 and the inner housing 240, which are respectively disposed on the outside and the inside along a radial direction, and the multi-cooling water channel 242 is disposed along a circumferential direction.

Components such as the second coolant passage 253, the coolant inlet hole 251, the coolant outlet hole 252, and the heat exchange plate 260 disposed in the rear cover 254 of the inverter housing 250 are the same as the first embodiment described above, and thus redundant description thereof will be omitted.

The motor housing 111 of the first embodiment may be composed of one piece, but the motor housing 210 of the second embodiment may be composed of two pieces of the outer housing 211 and the inner housing 240.

Each of the outer housing 211 and the inner housing 240 may be defined in a cylindrical shape.

Since the inner housing 240 is forcibly press-fitted and coupled into the outer housing 211, an outer circumferential portion of the inner housing 240 and an inner circumferential portion of the outer housing 211 may be in close contact with each other.

The outer housing 211 may further include an extension portion 212 having a semi-cylindrical shape extending in a radial direction.

A plurality of heat exchange cells 220 may be provided inside the expansion portion 212. The plurality of heat exchange cells 220 may define an oil passage 232. The plurality of heat exchange cells 220 may extend along a length direction of the outer housing 211.

The plurality of heat exchange cells 220 may be partitioned along a circumferential direction by a plurality of partition walls 230. The plurality of partition walls 230 may extend in a length direction of the outer housing 211, and may be spaced apart in a circumferential direction.

A plurality of communication passages 231 may be disposed at a front or rear end portion of the plurality of partition walls 230, and thus the plurality of communication passages 231 may connect the plurality of heat exchange cells 220 in a circumferential direction.

The plurality of communication passages 231 may be disposed in a zigzag pattern along a circumferential direction to allow oil to move in a zigzag pattern along the oil passage 232.

The plurality of heat exchange cells 220 may be composed of first to Lth heat exchange cells 22L. The plurality of heat exchange cells 220 may be composed of five heat exchange cells 220.

The first heat exchange cell 221 is connected to communicate with the oil inlet port 233 to allow oil to flow into the first heat exchange cell 221 through the oil inlet port 233. An oil communication hole may be disposed on an upper surface of the first heat exchange cell 221 to communicate with the oil inlet port 233.

The Lth heat exchange cell 22L (the fifth heat exchange cell 220) is connected to communicate with the oil injection port 234, and oil may be injected into the inner housing 240 through the oil injection port 234. An oil communication hole may be disposed on a lower surface of the Lth heat exchange cell 22L to communicate with the oil injection port 234.

A cell outlet hole may be disposed in the first heat exchange cell 221 to allow oil to move from the first heat exchange cell 221 to the oil inlet port of the oil pump 237 through the cell outlet hole. A cell inlet hole may be disposed in the second heat exchange cell 222 to allow oil applied with circulation power by the oil pump 237 to flow into the second heat exchange cell 222.

The inner housing 240 may include a plurality of coolant channels 242. Each of the plurality of coolant channels 242 may extend along a circumferential direction to define a first coolant passage 241. The plurality of coolant channels 242 may be spaced apart from each other along a length direction of the inner housing 240.

The plurality of coolant channels 242 may be defined by a plurality of passage formation portions 243. Each of the plurality of passage formation portions 243 may extend along a circumferential direction, and may protrude in a radially outward direction from a circumferential surface of the inner housing 240.

The plurality of coolant channels 242 and the plurality of passage formation portions 243 may be alternately disposed along a length direction.

A bridge 244 may be provided at the uppermost end of the inner housing 240.

The bridge 244 serves as a bridge connecting the oil passage 232 of the outer housing 211 and an inner side of the inner housing 240 in order to inject oil into the inner housing 240.

The bridge 244 may extend along a length direction of the inner housing 240. The bridge 244 may be disposed to protrude in a radially outward direction.

A plurality of oil injection ports 234 may be disposed at front and rear end portions of the bridge 244, and the plurality of oil injection ports 234 may be disposed to pass therethrough along a radial direction.

An upper end of the oil injection port 234 may be connected to communicate with the cell outlet hole of the Lth heat exchange cell 22L, and a lower end of the oil injection port 234 may be connected to communicate with an inner space of the inner housing 240. The oil injection port 234 may inject oil to the end coil of the stator coil.

Meanwhile, a coolant inlet port 2111 and a coolant outlet port 2112 may be disposed at an upper portion of the outer housing 211.

The coolant inlet port 2111 and the coolant outlet port 2112 may be connected to a coolant circulation system, and coolant cooled from the coolant circulation system may flow into the first coolant passage 241 of the inner housing 240 through the coolant inlet port 2111, and coolant heated in the coolant passage 241 may flow out through the coolant outlet port 2112 to circulate to the coolant circulation system.

The coolant inlet port 2111 may be spaced apart from the bridge 244 at a first interval along a circumferential direction. The coolant outlet port 2112 may be spaced apart from the bridge 244 at a second interval along a circumferential direction. The first interval may be larger than the second interval.

The coolant inlet port 2111 may be spaced apart from a front end of the outer housing 211 to a rear side thereof along a length direction at a preset interval. The coolant outlet port 2112 may be disposed at a rear end portion of the outer housing 211 to be spaced apart from the coolant inlet port 2111 along a length direction.

Coolant flowing in from the coolant inlet port 2111 may be configured to flow into the second coolant passage 253 of the inverter housing 250.

The coolant inlet port 2111 may communicate with the coolant inlet hole 251 disposed in the rear cover 254 of the inverter housing 250.

A first partition wall 2451 and a second partition wall 2452 may be disposed at an upper portion of the inner housing 240 to protrude in a radially outward direction.

The first partition wall 2451 may be extended to cross the coolant inlet port 2111 and the coolant outlet port 2112 to prevent coolant flowing in through the coolant inlet port 2111 from moving to the coolant outlet port 2112.

The first partition wall 2451 may be defined in a curved shape. A front end portion of the first partition wall 2451 may be connected to one side along a circumferential direction of the coolant inlet hole 251, and a rear end portion of the first partition wall 2451 may be connected to a rear end portion of the bridge 244. A rear end portion of the first partition wall 2451 may be disposed to be spaced apart forward from a rear end portion of the inner housing 240.

The second partition wall 2452 may extend in a direction crossing the first partition wall 2451. The second partition wall 2452 may extend along a length direction of the inner housing 240. A front end portion of the second partition wall 2452 may be connected to the other side along a circumferential direction of the coolant inlet hole 251, and a rear end portion of the second partition wall 2452 may be connected to a middle point of the first partition wall 2451, that is, a point crossing between the coolant inlet port 2111 and the coolant outlet port 2112 spaced apart from each other in a circumferential direction.

The second partition wall 2452 may be spaced apart from the bridge 244 along a circumferential direction.

The first partition wall 2451 and the second partition wall 2452 may be spaced apart from each other along a circumferential direction so as to correspond to an arc length of the coolant inlet hole 251.

The first partition wall 2451 and the second partition wall 2452 may define a coolant outlet guide portion 2461 that guides coolant flowing in through the coolant inlet port 2111 to the second coolant passage 253 of the inverter housing 250.

The second partition wall 2452 and the bridge 244 may be spaced apart from each other along a circumferential direction to correspond to an arc length of the coolant outlet hole 252.

The second partition wall 2452, the bridge 244, and a rear portion of the first partition wall 2451 may define a coolant inlet guide portion 2462 that guides coolant flowing out from the second coolant passage 253 of the inverter housing 250 to the first coolant passage 241 of the motor housing 210.

The coolant inlet guide portion 2462 may be disposed to communicate with the coolant outlet hole 252.

A coolant communication hole 2441 may be disposed at a lower portion of the bridge 244. The coolant communication hole 2441 may be configured to communicate the coolant inlet guide portion 2462 and the coolant channel 242.

When the coolant inlet port 2111 is viewed in a radial direction from an outside of the motor housing 210, the coolant inlet port 2111 may be spaced apart backward along a length direction of the inner housing 240 from the coolant inlet hole 251 of the inverter housing 250, but may be positioned at an upper portion of the coolant outlet guide portion 2461 disposed between the first partition wall 2451 and the second partition wall 2452.

When the coolant outlet port 2112 is viewed in a radial direction from an outside of the motor housing 210, the coolant outlet port 2112 may be disposed adjacent to a rear end along a length direction of the inner housing 240 from the coolant outlet hole 252 of the inverter housing 250, but may be positioned at a rear side than a rear end portion of the second partition wall 2452.

An outlet-side common header 2472 may be disposed at a rear side of the second partition wall 2452. The outlet-side common header 2472 serves to collect coolant flowing out from the plurality of coolant channels 242. One side of each of the plurality of coolant channels 242 may be spaced apart from the first partition wall 2451 in a circumferential direction.

The outlet-side common header 2472 may extend in an arc shape along a circumferential direction toward a rear end portion of the bridge 244 from the plurality of coolant channels 242. The outlet-side common header 2472 may be disposed such that a width of the passage decreases from the coolant channel 242 to the bridge 244 due to the shape of the first partition wall 2451. When the passage width decreases, a flow rate of coolant may increase, thereby increasing the flow rate of coolant flowing out through the coolant outlet port 2112.

The inlet-side common header 2471 may be disposed in a right side (clockwise) direction of the bridge 244. The inlet-side common header 2471 serves to distribute coolant flowing into the plurality of coolant channels 242. The other side of each of the plurality of coolant channels 242 may be spaced apart from the bridge 244 in a circumferential direction.

The coolant outlet guide portion 2461, the coolant inlet guide portion 2462, the coolant communication hole 2441 of the bridge 244, the inlet-side common header 2471, the coolant channel 242 and the outlet-side common header 2472, and the like may define a first coolant passage 241 inside the motor housing 210.

The rear cover 254 of the inverter housing 250 may include a coolant receiving portion 2541 to define a second coolant passage 253.

The coolant movement path of a drive system according to this configuration will be described in sequence as follows.

Coolant may flow into the coolant outlet guide portion 2461 through the coolant inlet port 2111 and move along a length direction of the coolant outlet guide portion 2461.

The coolant may flow into the second coolant passage 253 of the inverter housing 250 through the coolant inlet hole 251 from the coolant outlet guide portion 2461.

The coolant may move in a circumferential direction along the second coolant passage 253 of the inverter housing 250 to cool the inverter.

After cooling the inverter, the coolant may flow into the motor housing 210 through the coolant outlet hole 252.

The coolant may move in a length direction along the coolant inlet guide portion 2462 of the inner housing 240, and flow into the inlet-side common header 2471 through the coolant communication hole 2441 of the bridge 244.

The inlet-side common header 2471 may distribute the coolant to the plurality of coolant channels 242. The coolant may be distributed from the inlet-side common header 2471 to move in a circumferential direction along the plurality of coolant channels 242.

An intermediate common header 2473 may be further provided at the lowermost end of the inner housing 240. The intermediate common header 2473 may extend along a length direction of the inner housing 240.

The intermediate common header 2473 may have a difference in temperature of coolant flowing along the coolant channel 242 when the amount of heat absorbed by the coolant varies for each part along the length direction of the inner housing 240 during cooling by the coolant, and thus the coolant may be mixed in the intermediate common header 2473 in order to dissipate the coolant uniformly for each coolant channel 242.

According to this, the coolant may be mixed in the intermediate common header 2473 to eliminate the difference in temperature for each coolant channel 242, and achieve uniform distribution of the amount of heat dissipation of the coolant, thereby further improving heat dissipation performance.

The coolant may be cooled while moving along the plurality of coolant channels 242 through the intermediate common header 2473, and merging at the outlet-side common header 2472 again, and flowing out into the coolant circulation system through the coolant outlet port 2112.

1-12. (canceled)

13. A drive system for an electric automobile, the drive system comprising:
a motor housing that accommodates a stator and a rotor, and that includes a coolant inlet port and a coolant outlet port at an upper portion of the motor housing;
a first coolant passage located inside the motor housing and connected to the coolant inlet port and the coolant outlet port;
an inverter housing including a rear cover that defines a rear surface facing the motor housing in a length direction;
a heat exchange plate disposed inside the rear cover and defining a second coolant passage;
a coolant inlet hole disposed at an upper portion of the rear cover and configured to communicate with a part of the first coolant passage extending along an axial direction of the motor housing from the coolant inlet port to allow coolant flowing in through the coolant inlet port to flow into the second coolant passage; and
a coolant outlet hole disposed at the upper portion of the rear cover and spaced apart from the coolant inlet hole in a circumferential direction to allow the coolant moving along the second coolant passage to flow out into the first coolant passage.

14. The drive system of claim 13, wherein the motor housing comprises:
a semicircular portion that is disposed in a first section along a circumferential direction and that defines the first coolant passage; and
an extension portion that is disposed in a second section along the circumferential direction with a diameter larger than a diameter of the semicircular portion and that defines an oil passage to exchange heat with the first coolant passage.

15. The drive system of claim 13, wherein the first coolant passage comprises:
a plurality of heat exchange cells including a first heat exchange cell to an Nth heat exchange cell that extend along a length direction inside the motor housing;
a plurality of partition walls partitioning the plurality of heat exchange cells such that the plurality of heat exchange cells are spaced apart from each other along a circumferential direction; and
a plurality of communication passages disposed at an end portion of the plurality of partition walls and configured to communicate the first heat exchange cell to the Nth heat exchange cell in a circumferential direction to move the coolant in a zigzag pattern along a clockwise direction from the first heat exchange cell toward the Nth heat exchange cell.

16. The drive system of claim 15, wherein the first heat exchange cell is configured to communicate with the coolant outlet hole, and
wherein the Nth heat exchange cell is configured to communicate with the coolant inlet hole to guide the coolant flowing in from the coolant inlet port to the second coolant passage.

17. The drive system of claim 15, further comprising:
a barrier that is disposed inside the Nth heat exchange cell and that is configured to partition the coolant inlet port and the coolant outlet port.

18. The drive system of claim 14, wherein the oil passage comprises:
a plurality of heat exchange cells including a first heat exchange cell to an Mth heat exchange cell that extend along a length direction inside the extension portion;
a plurality of partition walls partitioning the plurality of heat exchange cells such that the plurality of heat exchange cells are spaced apart from each other along a circumferential direction; and
a plurality of communication passages disposed at an end portion of the partition walls and configured to communicate the first heat exchange cell to the Mth heat exchange cell in a circumferential direction to move oil from the first heat exchange cell positioned at a lowermost end of the motor housing toward the Mth heat exchange cell positioned at an uppermost end of the motor housing in a zigzag pattern along a counterclockwise direction.

19. The drive system of claim 18, wherein a plurality of oil injection ports extending in a radial direction is provided on a partition wall positioned at the uppermost end of the plurality of partition walls provided in the first coolant passage and is configured to communicate with the Mth heat exchange cell to inject the oil into the motor housing.

20. The drive system of claim 14, wherein the motor housing comprises:
an inner housing that includes the first coolant passage; and
an outer housing that is disposed at an outer side of the inner housing to surround the inner housing, and that includes the semicircular portion and the extension portion.

21. The drive system of claim 20, wherein the first coolant passage comprises:
a plurality of passage formation portions extending along the circumferential direction inside the motor housing, the plurality of passage formation portions being spaced apart from each other along the length direction of the motor housing;
a plurality of coolant channels disposed between the plurality of passage formation portions and configured to allow the coolant to flow along the circumferential direction;
an inlet-side common header disposed at a first end of the plurality of coolant channels and configured to distribute the coolant to the plurality of coolant channels; and
an outlet-side common header disposed at a second end of the plurality of coolant channels and configured to collect the coolant from the plurality of coolant channels.

22. The drive system of claim 21, wherein the oil passage comprises:
a plurality of heat exchange cells including a first heat exchange cell to an Lth heat exchange cell that extend along a length direction inside the extension portion;
a plurality of partition walls partitioning the plurality of heat exchange cells such that the plurality of heat exchange cells are spaced apart from each other along the circumferential direction; and
a plurality of communication passages disposed at an end portion of the plurality of partition walls to communicate the first heat exchange cell to the Lth heat exchange cell in the circumferential direction to move an from the first heat exchange cell positioned at a lowermost end of the extension portion toward the Lth heat exchange cell positioned at an uppermost end of the extension portion in a zigzag pattern along a counterclockwise direction.

23. The drive system of claim 20, wherein the inner housing further comprises:
a bridge extending along the length direction at the uppermost end of the inner housing; and
a plurality of oil injection ports disposed at front and rear end portions of the bridge, respectively, and configured to inject oil into the inner housing.

24. The drive system of claim 23, wherein the inner housing comprises:
a first partition wall having (i) a first end connected to a first end of the coolant inlet hole along a circumferential direction and (ii) a second end extending in a direction that crosses between the coolant inlet port and the coolant outlet port, to be connected to the rear end portion of the bridge;
a second partition wall having (i) a first side connected to a second end of the coolant inlet hole along a circumferential direction and (ii) a second side extending along a length direction of the inner housing to be connected to the first partition wall; and
a coolant outlet guide portion disposed between the first partition wall and the second partition wall and configured to allow the coolant flowing through the coolant inlet port to flow out into the coolant inlet hole.

25. The drive system of claim 24, wherein the inner housing further comprises:
a coolant inlet guide portion disposed between the second partition wall, the bridge, and a rear portion of the first partition wall and configured to communicate with the coolant outlet hole to guide the coolant flowing into the inner housing through the coolant outlet hole to the inlet-side common header, and
wherein the bridge is provided with a coolant communication hole and configured to communicate the coolant inlet guide portion and the inlet-side common header.

26. A drive system for an electric automobile, the drive system comprising:
a motor housing that accommodates a stator and a rotor, and that includes a coolant inlet port and a coolant outlet port;
an inverter housing including a rear cover that defines a rear surface facing the motor housing in a length direction;
a heat exchange plate disposed inside the rear cover and including a plurality of heat exchange fins;
a first coolant passage connected to the coolant inlet port and the coolant outlet port, and disposed inside a wall body of the motor housing;
a second coolant passage disposed at an inner side of the heat exchange plate; and
an oil passage disposed to be spaced apart in a radially outward direction from the first coolant passage at the inside of the wall body of the motor housing and configured to exchange heat with a coolant flowing through the first coolant passage.

27. The drive system of claim 26, comprising:
a coolant inlet hole disposed between the coolant inlet port and the second coolant passage and configured to communicate with the coolant inlet port and an inlet side of the second coolant passage, respectively, to allow the coolant flowing in through the coolant inlet port to flow into the second coolant passage; and
a coolant outlet hole disposed between the first coolant passage and the second coolant passage and configured to communicate with an outlet side of the second coolant passage and an inlet side of the first coolant passage, respectively, to allow the coolant moving along the second coolant passage to flow out to the first coolant passage.

28. The drive system of claim 27, wherein the heat exchange plate is disposed to be spaced apart from the rear cover in an axial direction of the inverter housing, and the second coolant passage is disposed between the rear cover and the heat exchange plate.

29. The drive system of claim 27, wherein the coolant inlet hole and the coolant outlet hole (i) define openings at the rear cover in a thickness direction and (ii) are spaced apart from each other in a circumferential direction at a first side of the rear cover.

30. The drive system of claim 27, wherein the motor housing comprises:
an inner housing that includes the first coolant passage; and
an outer housing that is disposed at an outer side of the inner housing to surround the inner housing.

31. The drive system of claim 30, wherein the inner housing comprises:
a bridge that is disposed between an upstream side and a downstream side of the first coolant passage with respect to a flow direction of the coolant, and that extends along the length direction from the uppermost end of the inner housing;
a first partition wall extending in a direction that crosses between the coolant inlet port and the coolant outlet port, a first end portion of which is connected to the bridge, and a second end portion of which is connected to the rear cover; and
a second partition wall extending along a length direction of the inner housing in a direction that crosses between the coolant inlet hole and the coolant outlet hole, a first end of which is connected to the first partition wall, and a second end of which is connected to the rear cover.

32. The drive system of claim 27, further comprising:
a central partition wall that is disposed at a first side of the heat exchange plate, that protrudes from the first side of the heat exchange plate, and that extends between the coolant inlet hole and the coolant outlet hole along a radial direction from the first side of the heat exchange plate,
wherein the coolant flowing in through the coolant inlet hole (i) moves in a circumferential direction along the second coolant passage from a first side of the central partition wall toward a second side of the central partition wall and (ii) flows out through the coolant outlet hole.
